(19) United States
(12) Patent Application Publication
(10) Pub. No.: US 2008/0302633 A1
(43) Pub. Date: Dec. 11, 2008

(54) Apparatus and method for coating and inspecting objects

(76) Inventors: Gerald F. Snow, Almont, MI (US); James Patrick DeFillipi, Leonard, MI (US)

Correspondence Address: WINSTON & STRAWN LLP;PATENT DEPARTMENT, 1700 K STREET, N.W., WASHINGTON, DC, 20006, US

(21) Appl. No.: 11/810,325

(22) Filed: Jun. 5, 2007

(51) Int. Cl. B65G 49/00

(52) U.S. Cl. 198/339.1

(57) ABSTRACT

An apparatus and method for inspecting objects for an inspection criteria thereon includes a conveyor to receive a plurality of objects, a removal assembly located along the conveyor for removing the objects, and an inspection system located along the conveyor prior to the removal assembly for inspecting the objects against a predetermined inspection criteria to determine to reject or pass the inspected objects and to actuate the removal assembly to remove the inspected objects from the conveyor that are passed and to leave the inspected objects that are rejected on the conveyor to subsequently exit the conveyor.

### BACKGROUND OF THE INVENTION

1. Field of the Invention

The present invention relates generally to inspection of objects and, more specifically, to an apparatus and method for coating and inspecting an inspection criteria on objects such as fasteners.

2. Description of the Related Art

It is known to apply a coating to objects such as fasteners with automated machinery. Once the coating is applied, the fasteners are inspected to determine if the coating or an additional attribute(s) such as thread pitch, thread diameter, thread length, fastener head style, or head marking of the fastener was sufficient to meet predetermined inspection criteria. For example, the fasteners are inspected to determine if the coating covers a predetermined area of the fasteners. This inspection of the coated fasteners is needed for processing quality control.

One method of inspecting the fasteners is to manually and visually inspect the fasteners. This may be performed randomly or in entirety. However, this inspection method is laborious and time consuming. Manual inspection requires the presence of an operator, limits processing speed, and is also dependent on variable parameters such as operator fatigue.

Another method of inspecting the fasteners is to use a machine vision system for automatically and continuously monitoring and controlling the processing of fasteners. An example of such a method is disclosed in U.S. Pat. No. 6,620,246 to Alaimo et al. In this patent, a process controller enables automatic and sequential start-up and shut-down of one or more fastener coating machines and/or subsystems for each machine. The process controller includes a fiber optic light source, a programmable logic controller, and a camera controller. A dial machine for coating internally threaded fasteners includes various ejector tubes for accommodating fasteners and may include a “purge” ejector tube for conveying fasteners or parts to a recycling location, a “defective parts” ejector tube for conveying fasteners to a defective parts bin, and a “good parts” ejector tube for conveying properly coated fasteners to a cooling location. Fasteners may be selectively ejected from a turntable track using bursts of compressed air from tubes. A camera housing is provided for conveying video images to the process controller. A suitable machine vision system may be used with the process controller.

Therefore, it is desirable to provide an apparatus to coat objects and then to inspect objects such as fasteners for process quality control. It is also desirable to provide an apparatus to automatically inspect coated fasteners after the coating process and additional attributes of the fasteners. It is further desirable to provide an apparatus and methodology in which passed objects from inspection flow to a good part removal and are removed and rejected objects from inspection flow to a default part removal and removed. Thus, there is a need in the art to provide an apparatus and methodology that meets at least one of these desires.

### SUMMARY OF THE INVENTION

It is, therefore, one object of the present invention to provide an apparatus and method for inspecting objects for process quality control.

It is another object of the present invention to provide an apparatus and method that automatically inspects objects.

It is yet another object of the present invention to provide an apparatus and method to coat fasteners and inspect coated fasteners and additional attributes of the fasteners.

To achieve one or more of the foregoing objects, the present invention is an apparatus for inspecting objects for an inspection criteria thereon. The apparatus includes a conveyor to receive a plurality of objects and a removal assembly located along the conveyor for removing the objects. The apparatus also includes an inspection system located along the conveyor prior to the removal assembly for inspecting the objects against a predetermined inspection criteria to determine to reject or pass the inspected objects and to actuate the removal assembly to remove the inspected objects from the conveyor that are passed and to leave the inspected objects that are rejected on the conveyor to subsequently exit the conveyor.

Also, the present invention is a method for coating and inspecting objects for an inspection criteria thereon. The method includes the steps of providing a conveyor, receiving a plurality of objects on the conveyor, and conveying the objects along the conveyor. The method also includes the steps of inspecting the objects with an inspection system located along the conveyor against a predetermined inspection criteria, determining to reject or pass the inspected objects, removing the passed objects from the conveyor with a removal assembly by actuating the removal assembly if the inspected objects are passed, and leaving the rejected objects on the conveyor if the inspected objects are rejected to subsequently exit the conveyor.

One advantage of the present invention is that an apparatus and method is provided for inspecting a flow of objects such as fasteners in an ordinate and incremental position at a high rate of speed. Another advantage of the present invention is that the an inspection methodology is provided in which passed objects from inspection flow to a good object removal and are removed and rejected objects from inspection flow to a default object removal and are removed. Yet another advantage of the present invention is that the apparatus and method automatically inspects coated objects such as fasteners and additional attributes of the fasteners after the coating process.

Other objects, features, and advantages of the present invention will be readily appreciated, as the same becomes better understood, after reading the subsequent description taken in conjunction with the accompanying drawings.

### BRIEF DESCRIPTION OF THE DRAWINGS

FIG. 1 is a front elevational view of an apparatus, according to the present invention.

FIGS. 1A and 1B are enlarged views of the apparatus of FIG. 1

FIG. 2 is a side elevational view of the apparatus of FIG. 1.

FIG. 2A is an enlarged elevational view of a portion of the apparatus in circle 2A of FIG. 2.

FIG. 3 is a flowchart of a method, according to the present invention, of inspecting objects using the apparatus of FIG. 1.

### DESCRIPTION OF THE PREFERRED EMBODIMENT(S)

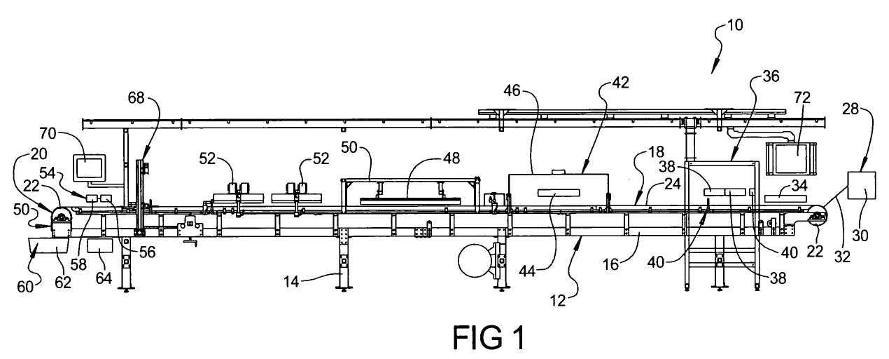

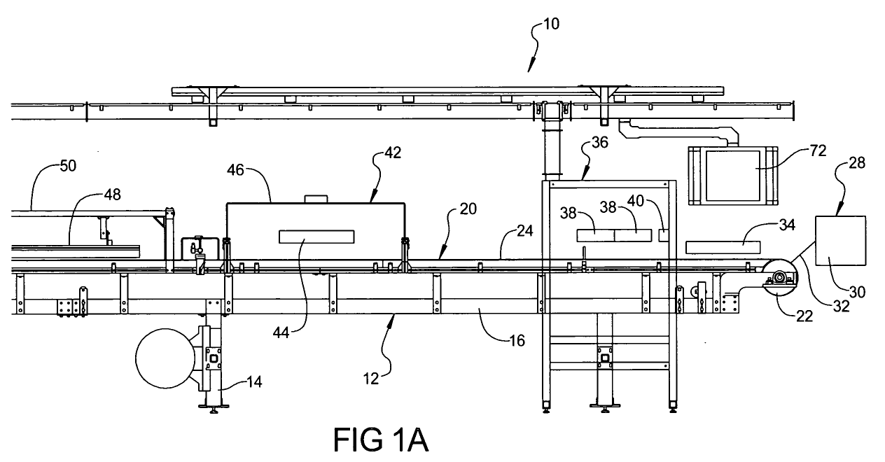

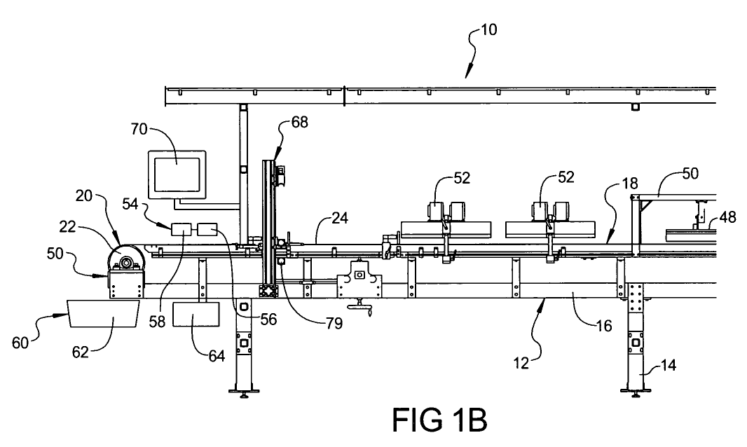

Referring now to the drawings, and in particular FIGS. 1, 1A, and 1B, one embodiment of an apparatus 10, according to the present invention, is shown. The apparatus 10 includes a support frame, generally indicated at 12. The support frame 12 includes at least one, preferably a plurality of columns 14 and at least one, preferably a plurality of beams 16 connected together by a suitable mechanism such as brackets and fasteners.

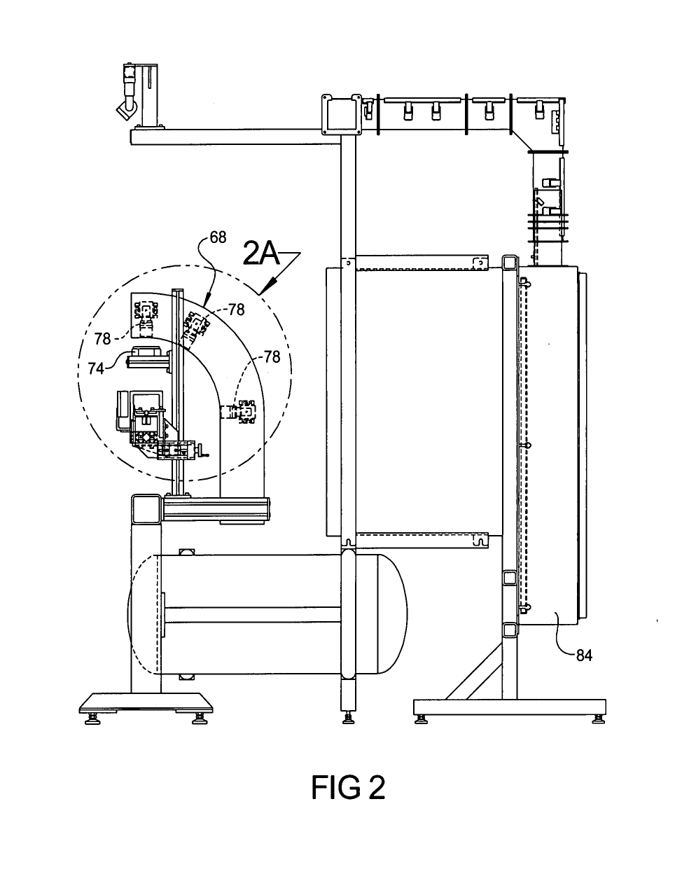

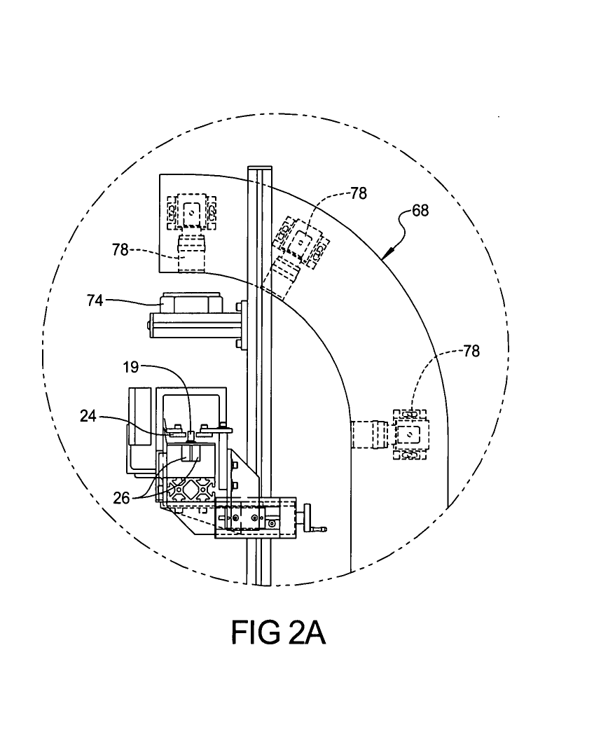

The apparatus 10 also includes a conveyor system, generally indicated at 18, for conveying objects such as fasteners 19 (FIG. 2A). The objects such as fasteners 19 each have a diameter of approximately 0.020 inches to approximately 2.0 inches and a length of approximately 0.030 inches to approximately 5.00 inches. It should be appreciated that the objects may be of a type other than fasteners.

The conveyor system 18 is of a magnetic and linear flow type. The conveyor system 18 includes a drive system, generally indicated at 20, for moving a belt 24 to be described. In one embodiment, the drive system 20 includes a plurality of rotatable wheels 22 rotatably supported on the support frame 12. The wheels 22 are rotatably connected to the support frame 12 by a suitable mechanism such as brackets and fasteners. Two of the wheels 22 are spaced longitudinally from each other with one wheel 22 located at one longitudinal end of the support frame 12 and the other wheel 22 located at the other end of the support frame 12 for a function to be described. The drive system 20 also includes a motor (not shown) connected to a rotatable shaft (not shown) on which one of the wheels 22 are rotatably mounted via a transmission (not shown). The motor is of a variable speed type and allows the speed of the belt 24 to be selectively adjusted to a desired consistent speed. Depending upon the type of fasteners processed, the practical belt speed typically ranges from about 30 to about 60 feet/minute, thereby enabling production of 10,000 to more than 160,000 parts/hour by the present invention, depending upon the part, its shape, and size. It should be appreciated that the motor is electrically connected to a source of power such as an apparatus controller 84 to be described.

Referring to FIGS. 1 through 2A, the conveyor system 18 includes at least one belt 24 disposed about the wheels 22. The belt 24 is disposed about two longitudinally spaced wheels 22. The conveyor system 18 includes at least one, preferably a pair of magnets 26 disposed below the belt 24. The magnets 26 extend longitudinally and are spaced laterally. The magnets 26 are operatively connected to the support frame 12 by a suitable mechanism such as brackets and fasteners. The fasteners 19 are magnetically held on the belt 24 via the magnetic field generated by the magnets 26 through the belt 24 for moving the fasteners 19. It should be appreciated that the wheels 22 and belt 24 can be readily adjusted on the conveyor system 18 to accommodate different types and sizes of objects such as fasteners. It should be appreciated that the belt 24 is closed to form a closed-loop.

The apparatus 10 also includes a feeder system, generally indicated at 28, positioned at one end of the conveyor system 18 to feed the fasteners 19 to the conveyor system 18. The fasteners 19 are orientated and aligned in a uniform manner by the feeder system 28. The feeder system 28 includes a vibratory feed bowl mechanism 30. The feeder system 28 also includes a gravity down track or vibratory in-line track mechanism 32 cooperating with the vibratory feed bowl mechanism 30 and the conveyor system 18. The track mechanism 32 is adjustable from zero degrees (0°) to thirty-five degree (35°) and positioned in a downward slope gravity or vibratory in-line linear type. The track mechanism 32 conveys the fasteners 19 from the vibratory feed bowl mechanism 30 and delivers the fasteners 19 to the conveyor system 18. The feeder system 28 may include a metering wheel or feed wheel mechanism (not shown) to meter the fasteners 19 from the track mechanism 32 to engagement with the conveyor system 18. The feed wheel mechanism moves the fasteners 19 and holds the fasteners 19 generally perpendicular to the surface of the belt 24 of the conveyor system 18. In another embodiment, the fasteners 19 could be fed by hand to the conveyor system 18. It should be appreciated that the feed wheel mechanism has independent vertical and horizontal adjustment. It should also be appreciated that a motor (not shown) for the feed wheel mechanism can be adjusted for relatively slow or fast speeds. It should further be appreciated that the feeder system 28 can take many different forms that are well known in the art.

Referring to FIGS. 1 through 2A, the apparatus 10 also includes a heating device 34 positioned after the feeder system 28 along the conveyor system 18. The heating device 34 is of a forced air type. The heating device 34 includes a blower (not shown) mounted to the support frame 12 by a suitable mechanism such as brackets and fasteners. The blower intakes air, heats the air, and discharges the heated air.

The heating device 34 may include a manifold (not shown) connected to the blower to receive and distribute the heated air to allow the heated air to be directed toward the fasteners 19. The heating device 34 pre-heats the objects such as the fasteners 19 to about 100° F. to about 450° F. prior to the application of any liquid coating materials. It should be appreciated that, in certain limited instances, such pre-heating of the fasteners 19 may assist in the distribution of liquid coating material applied to the fasteners 19.

The apparatus 10 includes a liquid applicator system, generally indicated at 36, located along the conveyor system 18, after the heating device 34, to apply a liquid coating to the fasteners 19. The liquid applicator system 36 includes at least one, preferably a plurality of applicators 38 for applying a liquid coating to the objects such as the fasteners 19. The applicators 38 are two dispensing modules on opposed sides of the fasteners 19 that release a preset or predetermined amount of material to a precise location. In one embodiment, the precise location is the flanged portion of the fastener 19. The applicators 38 used in connection with the present invention preferably utilize a nozzle diameter and range from about 0.005″ to about 0.120″ and are supplied with coating material under pressure of about 30 PSI. Preferably, the applicators 38 are Nordson® gun modules of approximately 0.032 in size. Although a variety of different dispensing applicators can be utilized for the purpose of metering precise high speed discrete shots of liquid material, a particularly preferred gun has been found to be a Nordson® Zero Cavity Module with a Number 276515 module manufactured by the Nordson Corporation of Norcross, Ga. Again, although a variety of different stages can be used, a particularly preferred stage has been found to be the 4500 Series ballbearing stage manufactured by the Daedal Division of the Parker Corporation of Harrison City, Pa. It should be appreciated that the applicators 38 apply liquid coating materials to objects such as fasteners that may have odd shapes, flanged heads, deep threads, extended threaded portions, off center openings, or are otherwise particularly difficult to completely or partially coat. It should also be appreciated that it is possible to use a single applicator 38 and a single shot of discrete material in connection with the present invention or any number of additional applicators 38 to deliver multiple discrete shots of material onto the fasteners 19. It is preferred that the applicators 38 be fully capable of applying at least 20,000 and preferably up to 150,000 discrete shots of material per hour.

The applicators 38 are supplied with liquid coating material from an off-line supply container (not shown). In one embodiment, the liquid coating material is a plastisol that is commercially available from ND Industries, Inc., of Clawson, Mich. It should be appreciated that the applicators 38 are capable of delivering high-speed accurate metered shots of a wide variety of liquid coating materials.

It should also be appreciated that, in other embodiments, the liquid coating materials may include, but are not limited to, fluorocarbons, hydrocarbon and fluorocarbon copolymers, silicones, waxes, petroleum greases, Teflon™, sealant materials, Hot Melt Adhesives, PUR's, and EEAs (ethylene/acrylic copolymer(s)) It should further be appreciated that the applicators 38 may be mounted on adjustable support mounts (not shown) on the support frame 12 to position the applicators 38 in three dimensions, e.g., longitudinally, laterally, and vertically, relative to the fasteners 19. It should be appreciated that the adjustment devices are manually operated.

The apparatus 10 includes at least one sensor 40 mounted in close proximity to the applicators 38. The sensor(s) 40 is of an optical type. When the sensor(s) 40 senses a predetermined portion of the fastener 19, it triggers a discrete shot of the liquid coating material to be precisely delivered onto the predetermined location of the detected fastener 19. A particularly preferred sensor for this purpose has been found to be the model FX7 manufactured by Sunx Sensors Corporation. An alternative preferred sensor has been found to be the Model No. PZ-101 manufactured by Keyance Corporation. It should be appreciated that the location, speed, and amount of material that is deposited are controllable by the applicators 38 acting in combination with the sensor 40. It should also be appreciated that the sensor 40 is conventional and known in the art.

Referring to FIGS. 1 through 2A, the apparatus 10 includes a curing device, generally indicated at 42, located along the conveyor 18, after the liquid applicator system 36, to cure the liquid coating material on the fasteners 19. The curing device 42 includes at least one heater 44 to heat the fasteners 19 after the application of the liquid coating material. The heater 44 is of an induction coil type. The heater 44 heats the fasteners 19 such that the coating material on the fasteners 19 cures from the inside to bond the liquid coating material to the fasteners 19. The curing device 42 may include a shield 46 disposed above the heater 44 and connected to the frame 12. It should be appreciated that, after the application of liquid coating material is deposited on the fasteners 19, the heater 44 raises the temperature of the fasteners 19 to an elevated temperature such as 350° F. It should also be appreciated that the heater 44 is conventional and known in the art.

The curing device 42 also includes least one, preferably a plurality of lamps 48. The lamps 48 are of a Quartz type that can be varied in temperature and intensity.

The lamps 48 cure the outside of the coating material on the fasteners 19. The lamps 48 are supported above the belt 24 by a support structure 50 made from brackets and fasteners connected to the support frame 12. It should be appreciated that, after exiting the heater 44, the heated fasteners 19 are subjected to a final post cure process by the lamps 48.

Referring to FIGS. 1 through 2A, the apparatus 10 also includes at least one, preferably a plurality of cooling devices 52 positioned along the conveyor system 18 after the final post curing. Each cooling device 52 is of a forced air type. The cooling device 52 includes a blower (not shown) mounted to the frame 12 by a suitable mechanism such as brackets and fasteners. The blower intakes air and discharges high velocity ambient air. The cooling device 52 also includes a manifold (not shown) connected to the blower to receive and distribute the cooled air to allow the cooled air to be directed toward the fasteners 19. The cooling device 52 cools the fasteners 19 to about 100° F. to about 150° F. prior to inspection.

The apparatus 10 also includes a removal assembly, generally indicated at 54, located at the end of the conveyor system 18. The removal assembly 54 includes a purge tube 56 connected to the support frame 12 by suitable means such as brackets and fasteners. The removal assembly 54 also includes an actuator 58 such as a solenoid-actuated valve connected to the purge tube 56 to allow pressurized air from an air source (not shown) to flow through the purge tube 56. The actuator 58 is also connected to the apparatus controller 84 to be described. The purge tube 56 is oriented to deliver pressurized air laterally across the surface of the belt 24 to remove fasteners 19 from the conveyor system 18.

The apparatus 10 includes a collector system, generally indicated at 60, disposed below the belt 24 at the end of the conveyor system 18. The collector system 60 includes a first collector 62 for objects such as fasteners 19 that have failed inspection. The first collector 62 may be supported by a cart (not shown) or the support frame 12. The first collector 62 may be a bucket and/or removable from the cart or support frame 12. The collector system 60 also includes a second collector 64 for objects such as fasteners 19 that have passed inspection. In one embodiment, the second collector 64 is a conveyor disposed below and generally perpendicular to the conveyor system 18.

The apparatus 10 also includes an inspection system, generally indicated at 68, for inspecting the objects such as fasteners 19 to reject or pass the fasteners 19 based on a predetermined criteria such as a coating thereon or other attributes of the fasteners 19. The inspection system 68 cooperates with the apparatus controller 84 to be described for controlling the inspection process. The inspection system 68 includes a camera controller or processor 70 having a microprocessor, memory, and input/output. The camera controller 70 may have a display for images and may permit manual operator setup, programming, and evaluation of the inspected criteria. The inspection system 68 also includes an interactive or human machine interface 72 such as an operator touch screen electrically connected to the camera controller 70. It should be appreciated that the camera controller 70 may be a separate controller or integrated into one controller with the apparatus controller 84. It should also be appreciated that the camera controller 70 may accommodate color or gray scale data acquisition. It should further be appreciated that encoders (not shown) may be provided to cooperate with the inspection system 68 to track objects such as the fasteners 19 prior to and/or after the inspection system 68 along the conveyor system 18.

The inspection system 68 further includes at least one, preferably a plurality of light sources 74. The light sources 74 illuminate the objects such as the fasteners 19 for the inspection system 68. The light sources 74 may be of any suitable type such as light emitting diode (LED) or fluorescent. It should be appreciated that the light sources 74 maintain a constant light emitting power and bath the fasteners 19 with light to reduce the affect of variations in ambient lighting during the inspection process.

The inspection system 68 further includes at least one inspection camera 78 or camera system for inspecting objects or parts such as the fasteners 19. Preferably, the inspection system 68 includes a plurality of cameras 78 or camera systems that may be designated as primary and secondary inspection cameras depending on the criteria to be inspected. As illustrated, two of the inspection cameras 78 are disposed above the belt 24 and one inspection camera 78 is disposed on the side of the belt 24 and are supported by the support frame 12 by a suitable mechanism such as brackets and fasteners. The inspection cameras 78 are electrically connected to the camera controller 70 previously described. Each inspection camera 78 takes a digital image of each object such as a fastener 19 and is sent to the camera controller 70. It should be appreciated that the camera controller 70 receives the image from each inspection camera 78 and determines whether each object such as the fastener 19 passes or fails a predetermined criteria and signals the apparatus controller 84. It should also be appreciated that a presence sensor 79 (FIG. 1B) such as a fiber optic through beam sensor or a laser sensor located on the apparatus 10 may be used as a camera trigger with the camera controller 70 and inspection cameras 78. It should further be appreciated that the inspections cameras 78 are conventional and known in the art. It should still further be appreciated that the apparatus controller 84 controls actuation of the actuator 58 via a signal from the camera controller 70.

The apparatus 10 includes an apparatus controller 84 for controlling the overall operation of the apparatus 10. The apparatus controller 84 includes a microprocessor, memory, and input/output. The apparatus controller 84 may have a display for images and may permit manual operator setup, programming, and evaluation of the apparatus 10. The apparatus controller 84 is connected to one or more components and/or subsystems of the apparatus 10. The apparatus controller 84 enables the automatic and sequential start-up and shut-down of one or more apparatuses 10 and/or subsystems for such apparatuses 10. It should be appreciated that the apparatus controller 84 for the apparatus 10 is of a programmable logic controller type. It should also be appreciated that the apparatus controller 84 is connected to other components of the apparatus 10 including those not shown or described.

In one embodiment of operation of the apparatus 10, objects or parts such as the fasteners 19 are loaded into the feeder 30. The fasteners 19 are fed from the feeder 30 to the track mechanism 32 and feed wheel mechanism and onto the belt 24. The magnetic belt 24 holds each fastener 19 in a vertical fashion with the shaft thereof facing upwardly above the belt 24. The drive system 20 moves the belt 24 longitudinally, thereby moving the fasteners 19 toward the removal assembly 54. It should be appreciated that the fasteners 19 are held by the belt 24 due to the magnetic attraction of the magnets 26 and moved therealong.

The fasteners 19 move pass the heating device 34 and are heated by the heated air from the blower. The fasteners 19 are moved by the belt 24 over the wheels 22 and are presented with the heads 14 facing downwardly. The fasteners 19 are sensed by the sensor(s) 40 and the applicators 38 are activated to release a predetermined amount of liquid coating material to a precise location to the flanged portion of the fastener 19. It should be appreciated that the fasteners 19 are moved by the belt 24 toward the curing device 42.

The fasteners 12 pass by the heater 44 and the heater 44 heats the fasteners 19 to an elevated temperature to bond and partially cure the inside of the coating material to the fasteners 19. After the heater 44, the fasteners 19 pass by the lamps 48 and the lamps 48 cure the outside of the coating material. After the curing device 42, the fasteners 19 move pass the cooling devices 52 and are cooled by the high velocity air from the blowers.

After cooling the coating on the fasteners 19, the fasteners 19 pass at least one presence sensor mounted to the support frame 12 in close proximity to the inspection system 68. When the sensor senses the fastener 19, it sends a signal to the camera controller 70 to indicate that a fastener 19 is present. The encoder is then activated by the apparatus controller 84 to track the fastener 19 along the conveyor system 18. It should be appreciated that the sensor and encoder are conventional and known in the art.

After the presence sensor, the fasteners 19 pass by at least one inspection camera 78 and the inspection camera 78 takes a digital image of each fastener 19 and is sent to the camera controller 70. In the embodiment illustrated, three inspection cameras 78 take a digital image of the fastener 19 as it travels in front of the cameras 78. The camera controller 70 compares the digital image to one stored in memory to determine whether the fastener 19 passes or fails at least one predetermined inspection criteria, for example, whether coating material is present on the fastener 19, whether the coating material covers a predetermined portion of the fastener 19, whether dimensional criteria of the fastener 19 has been met, etc.

If the camera controller 70 determines that the fastener 19 has failed or not passed the inspection criteria, the fasteners 19 exit the belt 24. The fastener 19 will fall off the end of the belt 24 due to the loss of magnetic attraction and fall into the first collector 62. This is the default position. If the camera controller 70 determines that the fastener 19 has passed the inspection criteria, the camera controller 70 will send a signal to the apparatus controller 84, which in turn sends a signal to the actuator 58, to allow air to the purge tube 56 to blow the fastener 19 off the belt 24 laterally to the second collector 64. This is the passed position. It should be appreciated that the default position is the failed position.

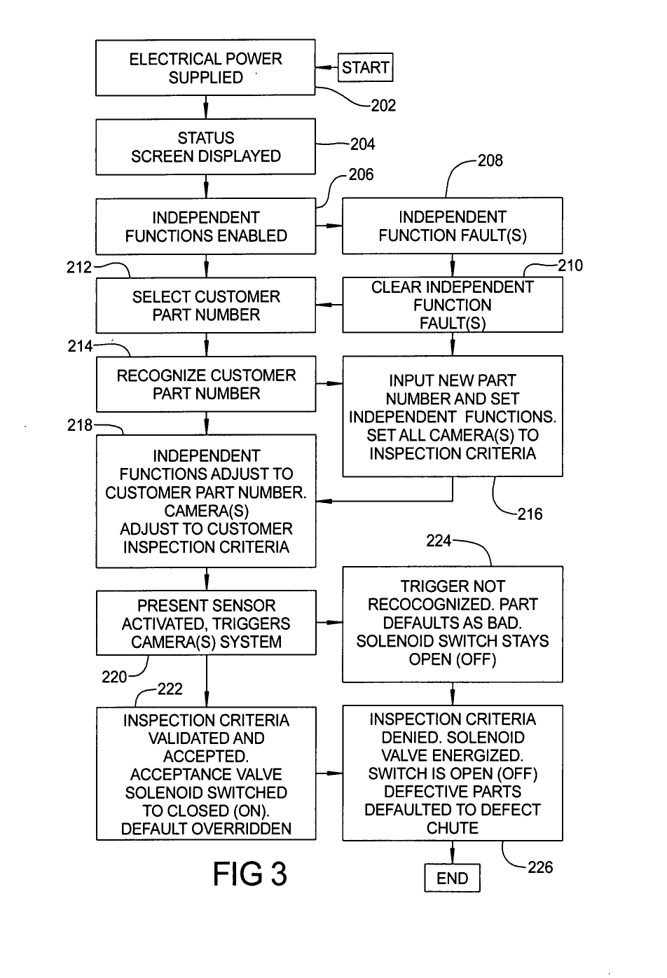

Referring to FIG. 3, a method of inspecting objects or parts such as fasteners with the apparatus 10 is shown. The methodology starts and advances to block 202. In block 202, the methodology includes the step of supplying electrical power to the apparatus 10. Power from a power source (not shown) is supplied to the apparatus controller 84, camera controller 70, human machine interface 72, and inspection cameras 78. It should be appreciated that power is also supplied to other components of the apparatus 10 not shown or described.

After block 202, the methodology advance to block 204 and displays the apparatus status screen on the interface 72. The apparatus status screen displays information such as machine status, individual device status, air pressure, belt speed, and induction heater settings. The methodology then advances to block 206 and enables independent functions of the apparatus 10 such as proper belt speed, proper induction heater settings, and proper air pressure. The apparatus controller 84 and interface 72 enable the independent functions of the apparatus 10 by validation of preset variables for processing belt speed, air pressure, and induction heater settings. From block 206, the methodology may advance to either block 208 or 212. In block 208, the methodology checks for independent function faults of the apparatus 10. The apparatus controller 84 and interface 72 check for independent function faults, such as improper air pressure, of the apparatus 10 by monitoring preset variables required for processing. The methodology then advances to block 210 and clears independent function faults of the apparatus 10. The apparatus controller 84 and interface 72 clear the independent function faults of the apparatus 10 by enabling and validating preset variables inputted by the operator of the apparatus 10.

From either block 206 or 210, the methodology advances to block 212 and selects a customer part number. The operator inputs a customer part number into the apparatus controller 84 via the interface 72 by selecting a customer part number from a predetermined list of customer part numbers. From block 212, the methodology advances to block 214 and the functions of the apparatus 10 recognize the customer part number. The apparatus controller 84 recognizes the customer part number and operates the apparatus 10 according to the functions associated with the customer part number. The methodology then advances to either blocks 216 or 218.

In block 216, the methodology inputs a new customer part number and sets independent functions of the apparatus 10 if no customer part number is selected from the predetermined list of customer part numbers. The operator inputs a new customer part number into the apparatus controller 84 via the interface 72 and camera controller 70 and sets independent functions of the apparatus 10 such as coating area, fastener length, thread pitch, and other inspection attributes defined by the customer into the apparatus controller 84 via the interface 72 such that the functions are related or associated with the new customer part number. The methodology also sets all camera systems to the customer's inspection criteria. The operator sets the camera systems to the customer's inspection criteria with the camera controller 70 by selecting from a predetermined list of inspection criteria such as previously described. From block 214 or block 216, the methodology advances to block 218.

In block 218, the methodology adjusts independent functions of the apparatus 10 to the customer part number. The apparatus controller 84 adjusts independent functions of the apparatus 10 such as air pressure, induction heater settings, belt speed, and inspection criteria related to the customer part number. The methodology also adjusts the camera systems to the customer inspection criteria. The camera controller 70 adjusts the camera systems to the customer inspection criteria by recognizing good or acceptable inspection criteria for acceptance and recognizing bad or unacceptable inspection criteria for rejection. The methodology advances to block 220 and activates a part or object presence sensor and triggers one or more inspection camera 78 for an inspection criteria such as a material detection of the coating on the fastener 19. The presence sensor is activated and sends a signal to the camera controller 70 and a signal to the inspection cameras 78. the methodology also sets an encoder to tract the object or part. The camera controller 70 sends a signal to the encoder to track the fastener 19 along the belt 24. After block 220, the methodology advances to either block 222 or 224 to be described.

In block 222, the methodology validates and accepts the inspection criteria. The inspection camera 78 sends a digital image of the fastener 19 passing thereby to the camera controller 70. The camera controller 70 compares the digital image to data stored in memory to validate the inspection criteria for the fastener 19. If the inspection criteria is valid, the camera controller 70 accepts the inspection criteria. The methodology activates the actuator 58 and the default is overridden. The controller closes or switches on the acceptance valve solenoid on the actuator 58 to allow air to the purge tube 56 to purge the fastener 19 from the belt 24 to the second collector 64. The methodology advances to block 226 to be described.

In block 224, the methodology denies the inspection criteria and the encoder continues to track the fastener 19. The camera controller 70 compares the digital image to data stored in memory to validate the inspection criteria of the fastener 19. If the inspection criteria is not valid, the camera controller 70 rejects the object to be inspected. The controller maintains the solenoid switch of the actuator 58 in the open or off position such that the fastener 19 exits the belt 24 into the first collector 62 in the failed position. From either block 222 or block 224, the methodology advances to block 226 to be described.

In block 226, the methodology denies the inspection criteria. The camera controller 70 compares the digital image to data stored in memory to validate the inspection criteria. If the inspection criteria is not valid, the camera controller 70 sends a signal to the apparatus controller 84 and rejects the inspected object. The methodology also ignores pass signals for a given distance of travel of the belt 24. The camera controller 70 sends a signal to the apparatus controller 84 to ignore pass signals for fasteners 19 for a given distance of travel of the belt 24. The controller opens the switch and maintains the solenoid valve of the actuator 58 in an open or off position. The methodology then ends. It should be appreciated that the default mode is the failed position.

Accordingly, the present invention is an inspection methodology and apparatus 10 that is designed to inspect a flow of objects or parts in an ordinate and incremental position at a high rate of speed.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

1. An apparatus for inspecting objects for an inspection criteria thereon comprising:
a conveyor to receive a plurality of objects;
a removal assembly located along said conveyor for removing the objects; and
an inspection system located along said conveyor prior to said removal assembly for inspecting the objects against a predetermined inspection criteria to determine to reject or pass the inspected objects and to actuate said removal assembly to remove the inspected objects from said conveyor that are passed and to leave the inspected objects that are rejected on said conveyor to subsequently exit said conveyor.

2. An apparatus as set forth in claim 1 including a collector system for collecting the inspected objects.

3. An apparatus as set forth in claim 2 wherein said collector system comprises a first collector for objects that have failed inspection and a second collector for collecting objects that have passed inspection.

4. An apparatus as set forth in claim 3 wherein said removal assembly includes a purge tube located along said conveyor prior to said collector system.

5. An apparatus as set forth in claim 4 wherein said removal assembly includes an actuator connected to said purge tube to allow air from a source to remove inspected objects from said conveyor.

6. An apparatus as set forth in claim 5 including a controller communicating with said actuator to activate said actuator, wherein said controller activates said actuator to allow air to remove objects from said conveyor in response to a passed condition.

7. An apparatus as set forth in claim 1 wherein said conveyor comprises a magnetic conveyor and belt to receive the objects.

8. An apparatus as set forth in claim 7 wherein said magnetic conveyor and belt comprises a belt and at least one magnetic assembly extending longitudinally beneath a portion of said belt.

9. An apparatus as set forth in claim 1 wherein said inspection system comprises at least one camera, a light source, and a camera controller communicating with at least one camera.

10. An apparatus as set forth in claim 10 wherein said inspection system includes at least one sensor for sensing a presence of an object on said conveyor for triggering said at least one camera.

11. An apparatus for coating and inspecting objects comprising:
a conveyor to receive a plurality of objects;
at least one applicator located along said conveyor to apply a coating material to a portion of the objects;
a removal assembly located along said conveyor after said at least one applicator for removing the objects; and
an inspection system located along said conveyor after said at least one applicator but prior to said removal assembly for inspecting the objects against a predetermined inspection criteria to determine to reject or pass the inspected objects and to actuate said removal assembly to remove the inspected objects from said conveyor that are passed and to leave the inspected objects that are rejected on said conveyor to subsequently exit said conveyor.

12. An apparatus as set forth in claim 11 wherein said at least one applicator comprises a liquid applicator system to apply a liquid coating to the objects.

13. An apparatus as set forth in claim 12 including a heating device located along said conveyor prior to said at least one applicator to heat the objects to an elevated temperature.

14. An apparatus as set forth in claim 12 including a curing device located along said conveyor after said at least one applicator to cure the coating material on the coated fasteners.

15. An apparatus as set forth in claim 14 wherein said curing device comprises an induction heating coil.

16. An apparatus as set forth in claim 14 wherein said curing device comprises at least one quartz or infrared lamp.

17. An apparatus as set forth in claim 11 wherein said conveyor comprises a magnetic conveyor and belt to receive the objects.

18. An apparatus as set forth in claim 17 wherein said magnetic conveyor and belt comprises a belt and at least one magnetic assembly extending longitudinally beneath a portion of said belt.

19. An apparatus as set forth in claim 11 wherein said inspection system comprises at least one camera, a light source, and a camera controller communicating with at least one camera.

20. An apparatus for coating and inspecting objects comprising:
a magnetic conveyor to receive a plurality of objects;
at least one applicator located along said conveyor to apply a coating material to a portion of the objects;
a removal assembly located along said conveyor after said at least one applicator for removing the objects; and
an inspection system comprising at least one camera, a light source, and a camera controller communicating with at least one camera located along said conveyor after said at least one applicator but prior to said removal assembly for inspecting the objects against a predetermined inspection criteria to determine to reject or pass the inspected objects and to actuate said removal assembly to remove the inspected objects from said conveyor that are passed and to leave the inspected objects that are rejected on said conveyor to subsequently exit said conveyor.
